(19) United States
(12) Patent Application Publication
(10) Pub. No.: US 2013/0282487 A1
(43) Pub. Date: Oct. 24, 2013

(54) SYSTEM, METHOD, AND COMPUTER-READABLE MEDIUM FOR DYNAMIC ADVERTISING, SUBMISSION EVALUATION, AND INPUT CONVERSION

(71) Applicant: Robert Richard Walling, III, Atlanta, GA (US)

(72) Inventor: Robert Richard Walling, III, Atlanta, GA (US)

(21) Appl. No.: 13/792,000

(22) Filed: Mar. 9, 2013

Related U.S. Application Data
(60) Provisional application No. 61/637,289, filed on Apr. 24, 2012.

(51) Int. Cl. G06Q 30/02; G09B 7/00

(52) U.S. Cl. CPC G06Q 30/0255; H04L 67/42; G09B 7/00
USPC 705/14.53; 709/203; 434/322

(57) ABSTRACT

Disclosed herein is an apparatus, comprising one or more databases relating interactive media, auctions, and user accounts, the user accounts comprising login information, advertising file information, and bidding information; and in communication with one or more user devices, wherein the one or more user devices may be used to place a bid in one of the auctions by one of the user accounts for one of the interactive media, and wherein an auction ends and a winning bid is determined, and the advertising file information associated with the winning bid is dynamically incorporated into the interactive media.

This application claims the priority benefit under 35 U.S.C. §119(e) from Provisional Application No. 61/637,289, filed Apr. 24, 2012.

This application relates to Provisional Application No. 61/531,045 filed Sep. 5, 2011, titled “System, Method, and Computer-Readable Medium for Tutoring with Video Games and Interactive Video,” the entirety of which is herein incorporated by reference.

### FIELD OF THE INVENTION

This invention relates generally to advertising and more specifically to dynamically updating advertising in various platforms.

Moreover, this invention relates to allowing users to submit media for evaluation and sharing revenue with selected media.

Furthermore, this invention relates to receiving input in an expected format and convert the input into a more digestible format.

### BACKGROUND OF THE INVENTION

These days, users frequently consume various media online and through applications (called apps). For instance, websites exists that allow users to play interactive media, such as video games. Additionally, users download apps. One thing providers of media providers struggle with is how to monetize their product. Users often expect website and app interactive media to be provided for free. Frequently media providers look to advertising to make money. However, the ads are disjointed from the media content and frequently disrupt the user's enjoyment of the media content. This can annoy the user. This can also allow the user to ignore the ad until it ends, preventing the advertiser from getting what it paid for. What is needed is a way to dynamically embed advertising into media content.

Additionally, some websites allow users to upload videos or video games that they created. However, typically these websites do not filter what users upload. Additionally, the websites typically make money off of advertising, while the users do not. What is needed is a way for websites to filter what they display and for websites to easily share revenue with the users that create the content.

Furthermore, students typically take notes sequentially. However, when they study, students frequently try to memorize a topic by viewing only a portion of the topic and trying to recall some other portion of the topic. One way students accomplish this is by converting their notes into flash cards. What is needed is a way to easily convert information into a more digestible format.

### SUMMARY OF THE INVENTION

Disclosed herein is a system, comprising one or more servers comprising one or more databases relating interactive media, auctions, and user accounts, the user accounts comprising login information, advertising file information, and bidding information; one or more user devices comprising communication the one or more servers, wherein the one or more user devices may be used to place a bid in one of the auctions by one of the user accounts for one of the interactive media, and wherein an auction ends and a winning bid is determined, and the advertising file information associated with the winning bid is dynamically incorporated into the interactive media.

Disclosed herein is a method, comprising the steps of relating interactive media, auctions, and user accounts, the user accounts comprising login information, advertising file information, and bidding information; and communicating with one or more user devices, wherein the one or more user devices may be used to place a bid in one of the auctions by one of the user accounts for one of the interactive media, and wherein an auction ends and a winning bid is determined, and the advertising file information associated with the winning bid is dynamically incorporated into the interactive media.

Disclosed herein is an apparatus, comprising one or more databases relating interactive media, auctions, and user accounts, the user accounts comprising login information, advertising file information, and bidding information; and in communication with one or more user devices, wherein the one or more user devices may be used to place a bid in one of the auctions by one of the user accounts for one of the interactive media, and wherein an auction ends and a winning bid is determined, and the advertising file information associated with the winning bid is dynamically incorporated into the interactive media.

Disclosed herein is a computer-readable medium, comprising relating interactive media, auctions, and user accounts, the user accounts comprising login information, advertising file information, and bidding information; and communicating with one or more user devices, wherein the one or more user devices may be used to place a bid in one of the auctions by one of the user accounts for one of the interactive media, and wherein an auction ends and a winning bid is determined, and the advertising file information associated with the winning bid is dynamically incorporated into the interactive media.

Disclosed herein is a system, comprising a user device comprising communication with one or more servers, the one or more servers comprising one or more databases relating interactive media, auctions, and user accounts, the user accounts comprising login information, advertising file information, and bidding information, wherein the one or more user devices may be used to place a bid in one of the auctions by one of the user accounts for one of the interactive media, and wherein an auction ends and a winning bid is determined, and the advertising file information associated with the winning bid is dynamically incorporated into the interactive media.

Disclosed herein is a method, comprising the steps of collecting login information from a user, communicating collected login information to a database, receiving account information associated with collected login information from the database, receiving bid information from the user, wherein the bid information is associated with an auction, and wherein the winner of the auction may designate an advertising file to be embedded in an interactive medium.

Disclosed herein is an apparatus, comprising communication with one or more servers, the one or more servers comprising one or more databases relating interactive media, auctions, and user accounts, the user accounts comprising login information, advertising file information, and bidding information, wherein the one or more user devices may be used to place a bid in one of the auctions by one of the user accounts for one of the interactive media, and wherein an auction ends and a winning bid is determined, and the advertising file information associated with the winning bid is dynamically incorporated into the interactive media.

Disclosed herein is a computer-readable medium, comprising collecting login information from a user, communicating collected login information to a database, receiving account information associated with collected login information from the database, receiving bid information from the user, wherein the bid information is associated with an auction, and wherein the winner of the auction may designate an advertising file to be embedded in an interactive medium.

Disclosed herein is a system, comprising one or more servers configured to specify conditions for interactive media, receive interactive media from user devices, select one or more interactive media from the received interactive media, and make the selected interactive media available in accordance with the specified conditions.

Disclosed herein is a method, comprising the steps of specifying conditions for interactive media, receiving interactive media from user devices, selecting one or more interactive media from the received interactive media, and making the selected interactive media available in accordance with the specified conditions.

Disclosed herein is an apparatus, comprising one or more processors and memory configured to specify conditions for interactive media to be provided to user devices, receive interactive media from user devices, select one or more interactive media from the received interactive media, and make the selected interactive media available in accordance with the specified conditions.

Disclosed herein is a computer-readable medium, comprising specifying conditions for interactive media, receiving interactive media from user devices, selecting one or more interactive media from the received interactive media, and making the selected interactive media available in accordance with the specified conditions.

Disclosed herein is a system, comprising one or more user devices configured to receive specified conditions for interactive media from one or more servers, send one or more interactive media to the one or more servers, wherein one or more of the interactive media sent to the one or more servers by the one or more user devices is selected, and receive the selected interactive media, wherein the selected interactive media is made available by the one or more servers in accordance with the specified conditions.

Disclosed herein is a method, comprising the steps of receiving specified conditions for interactive media from one of more servers, sending one or more interactive media to the one or more servers, wherein one or more of the interactive media sent to the one or more servers is selected, and receiving the selected interactive media, wherein the selected interactive media is made available by the one or more servers in accordance with the specified conditions.

Disclosed herein is an apparatus, comprising one or more processors and memory configured to receive specified conditions for interactive media from one or more servers, send one or more interactive media to the one or more servers, wherein one or more of the interactive media sent to the one or more servers is selected, and receive the selected interactive media, wherein the selected interactive media is made available by the one or more servers in accordance with the specified conditions.

Disclosed herein is a computer-readable medium, comprising receiving specified conditions for interactive media from one of more servers, sending one or more interactive media to the one or more servers, wherein one or more of the interactive media sent to the one or more servers is selected, and receiving the selected interactive media, wherein the selected interactive media is made available by the one or more servers in accordance with the specified conditions.

Disclosed herein is a system, comprising one or more servers configured to receive formatted input from one or more user devices, wherein the received formatted input is formatted in one of one or more expected formats, convert the received formatted input into an output that is more digestible, and make the more digestible output available to the one or more user devices.

Disclosed herein is a method, comprising the steps of receiving formatted input, wherein the received formatted input is formatted in one of one or more expected formats, converting the received formatted input into an output that is more digestible, and making the more digestible output available.

Disclosed herein is an apparatus, comprising one or more processors and memory configured to receive formatted input, wherein the received formatted input is formatted in one of one or more expected formats, convert the received formatted input into an output that is more digestible, and make the more digestible output available.

Disclosed herein is a computer-readable medium, comprising receiving formatted input, wherein the received formatted input is formatted in one of one or more expected formats, converting the received formatted input into an output that is more digestible, and making the more digestible output available.

Disclosed herein is a system, comprising one or more user devices configured to transmit formatted output to one or more servers, wherein the transmitted formatted output is formatted in one of one or more expected formats, and wherein the one or more servers are configured to convert the transmitted formatted output into an input that is more digestible, and make the more digestible input available to the one or more user devices.

Disclosed herein is a method, comprising the steps of transmitting formatted output, wherein the transmitted formatted output is formatted in one of one or more expected formats, wherein the transmitted formatted output is converted into an input that is more digestible, and receiving the more digestible input.

Disclosed herein is an apparatus, comprising one or more processors and memory configured to transmit formatted output, wherein the transmitted formatted output is formatted in one of one or more expected formats, wherein the transmitted formatted output is converted into an input that is more digestible, and receive the more digestible input.

Disclosed herein is a computer-readable medium, comprising transmitting formatted output, wherein the transmitted formatted output is formatted in one of one or more expected formats, wherein the transmitted formatted output is converted into an input that is more digestible, and receiving the more digestible input.

The above described and other features are exemplified by the following figures and detailed description.

### BRIEF DESCRIPTION OF THE DRAWINGS

FIG. 1, comprising FIGS. 1a and 1b, is a flow diagram illustrating an exemplary embodiment of a method for adding files to an account.

FIG. 2, comprising FIGS. 2a and 2b, is a flow diagram illustrating an exemplary embodiment of a method for evaluating received bids.

FIG. 3, comprising FIGS. 3a and 3b, is a flow diagram illustrating an exemplary embodiment of a method for automating bids.

FIG. 4 is a flow diagram illustrating an exemplary embodiment of a method for handling a winning bid.

FIG. 5 is an exemplary embodiment of a user interface allowing a user to add files to an account.

FIG. 6 is an exemplary embodiment of a user interface displaying file details.

FIG. 7 is an exemplary embodiment of a user interface displaying auction details.

FIG. 8 is an exemplary embodiment of a user interface allowing a user to automate bidding.

FIG. 9 is an exemplary embodiment of a user interface that may be displayed after an auction.

FIG. 10 is an exemplary embodiment of a screenshot of an interactive media.

FIG. 11 is an exemplary embodiment of a screenshot of an interactive media with an embedded advertisement.

FIG. 12 is a flow diagram illustrating an exemplary embodiment of a method for selecting a subset of media from a set of received media.

FIG. 13 is an exemplary embodiment of a user interface allowing a user to add interactive media.

FIG. 14 is an exemplary embodiment of a user interface allowing a user to submit interactive media.

FIG. 15 is a flow diagram illustrating an exemplary embodiment of a method for converting input into a more digestible format.

FIG. 16 is an exemplary embodiment of a screenshot of a user's notes.

FIG. 17 is an exemplary embodiment of a screenshot of a quiz question.

FIG. 18 is an exemplary embodiment of a screenshot of an answer screen for a quiz question.

FIG. 19 is a flow diagram illustrating an exemplary embodiment of a method for converting an outline into a quiz.

FIG. 20 is an exemplary embodiment of a system in accordance with the present invention.

### DETAILED DESCRIPTION

Reference throughout this specification to “exemplary embodiment” or “one embodiment” or “an embodiment” means that a particular feature, structure, or characteristic described in connection with the embodiment is included in at least one embodiment of the present invention. Thus, appearances of the phrases “in an exemplary embodiment” or “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of user interfaces, screenshots, flow diagrams, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

As used herein, “bidding” and “auction” are used interchangeably. As used herein, “interactive media” and “media” includes “video games” and “videos”, as well as a single “video game” or “video”.

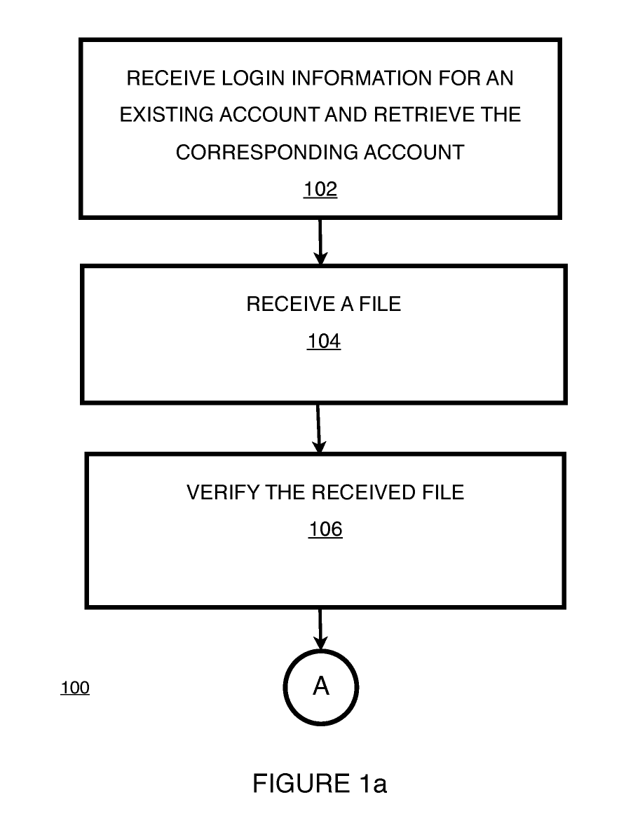

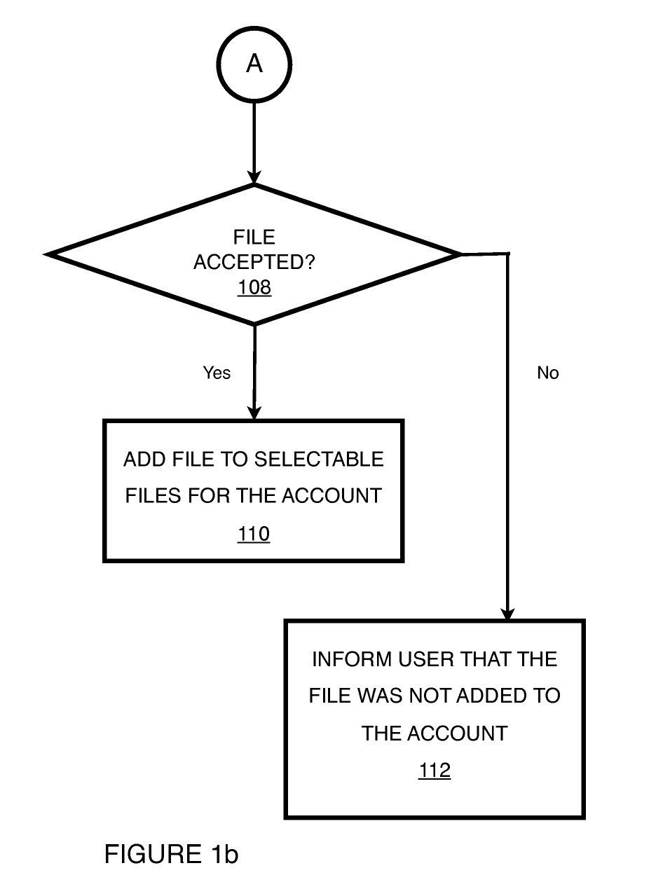

Referring to FIG. 1, an exemplary embodiment of a flow diagram of a method 100 for adding files to an account is illustrating. In step 102, a user with an existing account may enter login information in a user interface. For example, the user may enter a unique username and corresponding password in those respective fields. If the user does not have an existing account, the user may create a new account (not shown). Once the user enters login information, that information may be sent to the appropriate location. For example, in an exemplary embodiment, the user may enter information into fields appearing on a website on a computer and the information may be transmitted over a network, such as, for example, the Internet, and to a computer, such as a server. In another exemplary embodiment, the user may enter information into fields appearing on an application (or “app”) on a mobile communication device, such as a smart phone, in communication with a computer, such as a server via a network, such as the Internet. The appropriate user information may then be retrieved and sent back to the user. For example, a username field may define a key in a database, such as an SQL database. A password field may be required to ensure that only an authorized user accesses a particular account. If the user enters appropriate information corresponding to an account, then the user may be logged in. In an exemplary embodiment, information from a database associated with the particular account may be returned to the user when the user logs in.

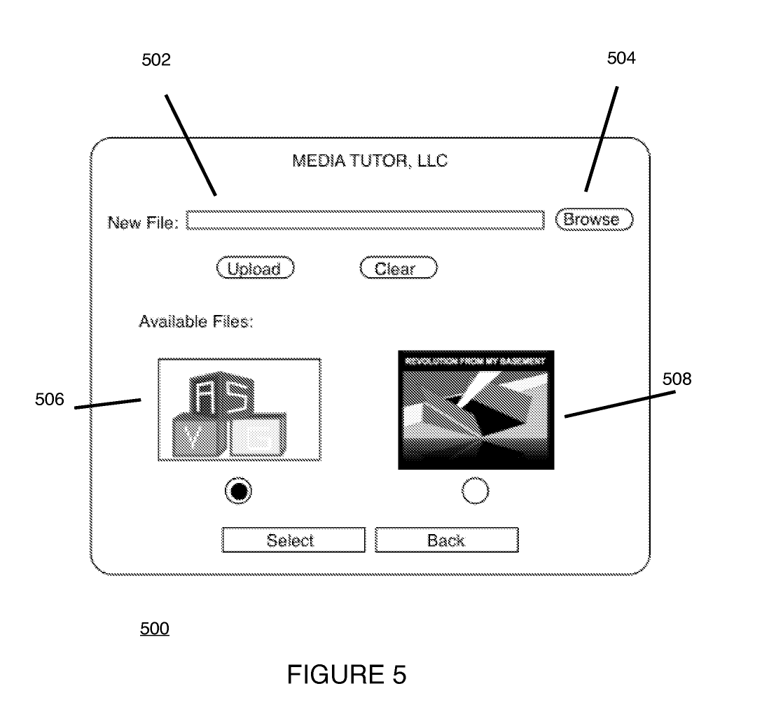

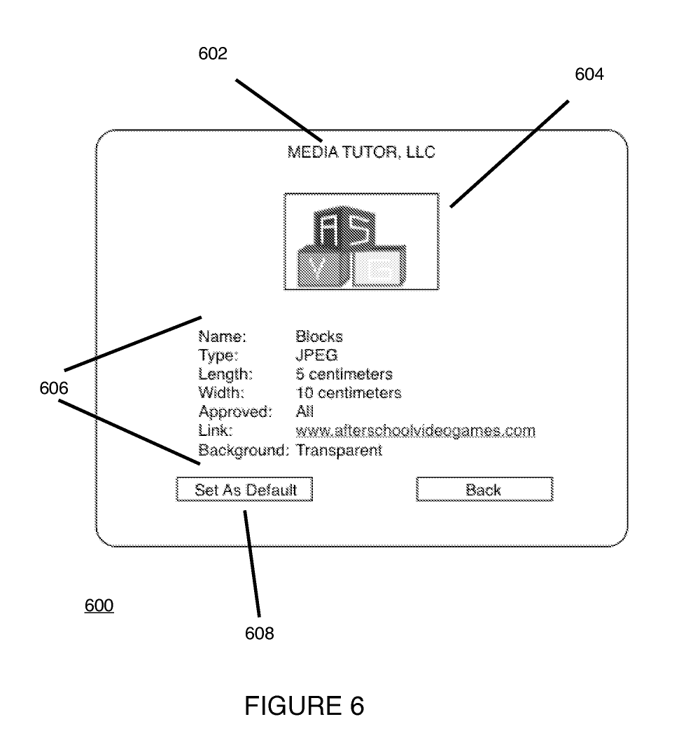

In step 104, the user may add a file. FIG. 5 illustrates an exemplary embodiment of a user interface 500 that may allow a user to add a file. A user may type the path of a file in bar 502 or press button 504 and may choose a file from a pop up menu in a known method. In this exemplary user interface, the user may see files that have previously been uploaded 506 and 508. A file may be any type of data, such as, for example, a picture, video, audio, etc., and any information associated with the data type, such as a name, dimensions, etc. The data may be in any format. For example, picture data may be a jpeg, gif, or any other image data file type. The associated information may be entered by the user, derived from data, metadata of the data, determined by an external party, etc. For example, in an exemplary embodiment, associated information entered by the user may be a link associated with a picture when the picture is clicked; associated information derived from data may be the dimensions of the picture; associated information obtained from metadata may be the date the picture was created; and associated information determined by an external party may be the age appropriateness of the picture. FIG. 6 illustrates an exemplary embodiment of a user interface 600 of a received file 604 and the associated information with such the received file 606. Field 602 may contain a name associated with an account. A button 608 may allow a user to set the received file as a file that may be selected by default when the account bids on an auction.

In step 106, the received file may be verified. For example, the file may be checked against a size limit; the file may be checked against certain defined dimensions; the file may be checked for a certain color scheme; the file may be checked for appropriate content; in the case of moving pictures, the file may be check for continuity; etc.

A determination may be made at step 108 as to whether the received file was accepted. If the file was accepted, then the file may be added to the account 110 and may be available to the user. In the file was not accepted, then the user may be informed that the file was not added to the account 112.

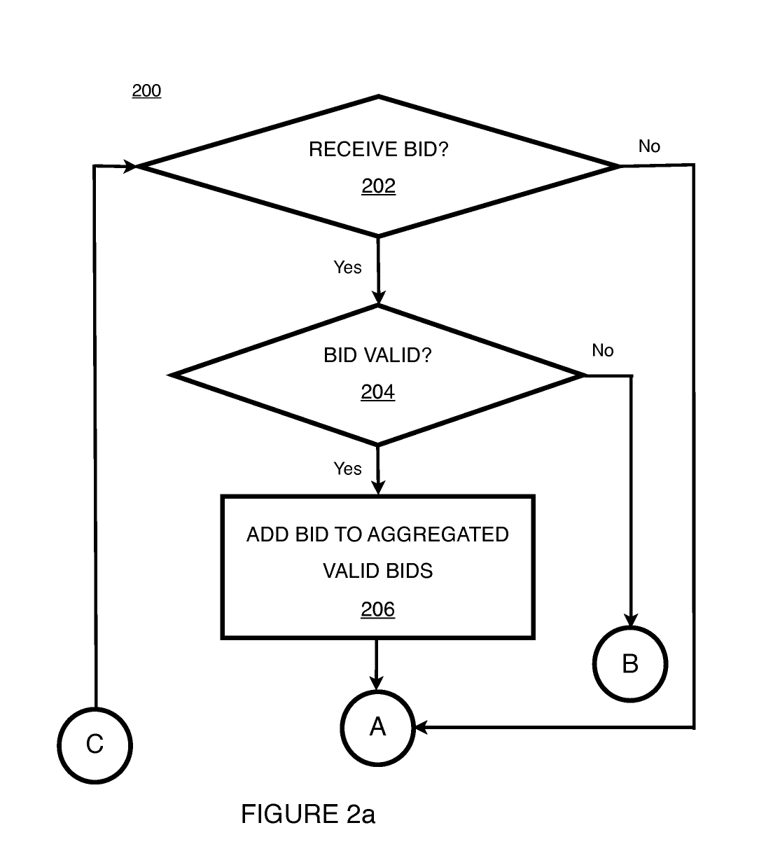

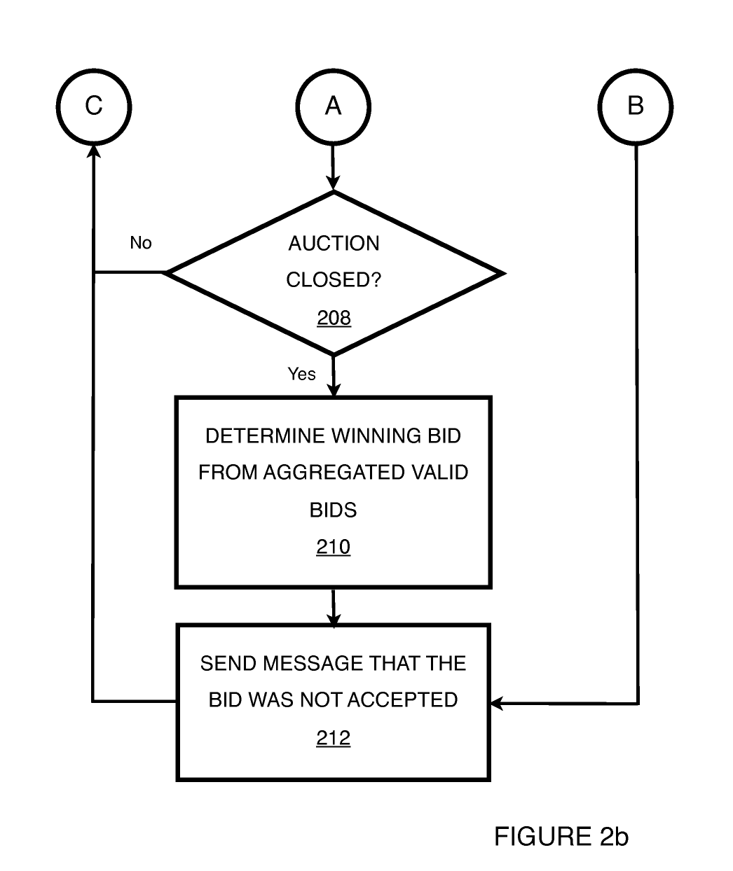

Referring now to FIG. 2, an exemplary embodiment of a flow diagram for a method 200 for aggregating and evaluating bids is illustrated. At 202, the method 200 may determine if a bid is received. If no bid is received, the method 200 may determine if the auction is closed 208. If the auction is not closed, the method 200 may determine if a bid is received 202. The method 200 may continue to wait for either a bid to be received 202 or the bidding to close 208 (“waiting period”). If a bid is received, the method 200 may determine if the bid is valid 204. A bid could be invalid for a variety of reasons. For example, if a user tries to place a bid after time expired, if a user tries to place a bid lower than current bid, if a user tries to bid more than is in the user's account, if a user tries to place a bid to use a file chosen is inappropriate for the bid, or for any other reason why a bid may be invalid. A file may be inappropriate for a variety of reasons. A file may contain a picture with colors that do not go with media on which the ad will be embedded; the picture may be outside of the expected dimensions; the content may have content that is inappropriate for the particular game being bid on; the particular auction may be expecting a file with a link and the file may have no link; the particular auction may be expecting a file with multiple pictures but the file only has a single picture; or any other reason a file may be inappropriate.

If the bid is not accepted, then a message that the bid was not accepted may be sent to the user with the rejected bid 212 and then method 200 may continue to the waiting period and wait for more bids 202. If the bid is accepted, then the bid may be added to the aggregated bid list 206 and then the method 200 may continue to the waiting period and check to see if the bidding is closed 208.

Once the auction closes, the winning bid may be determined from the valid aggregated bids 210. Generally, the user that placed the last valid bid will be the winning bidder. However, in other exemplary embodiments, determining a winning bid may be more complicated. For example, users may be able to bid the same price, but offer to reduce the time allotted or geographical reach or platforms the ad is embedded in or any other alteration. Any other auction method may be used.

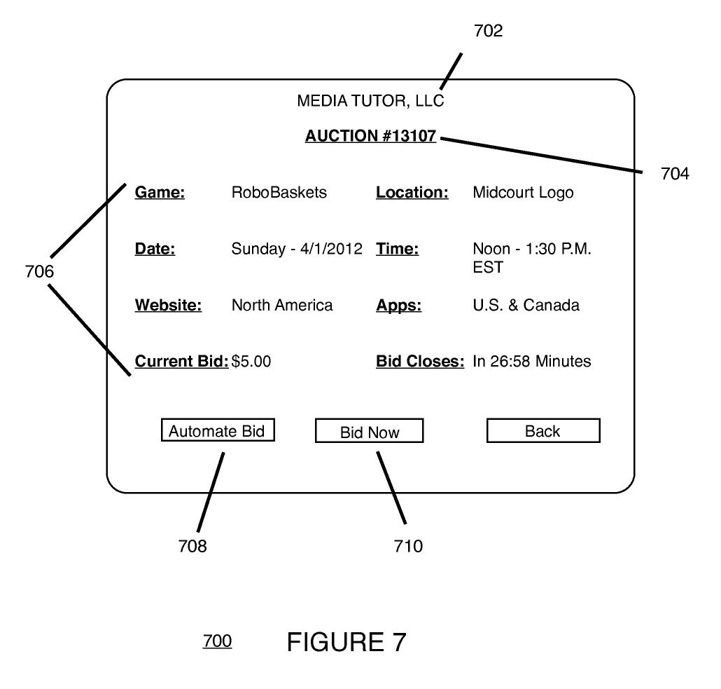

Referring now to FIG. 7, an exemplary embodiment of a user interface 700 of an auction screen is illustrated. Field 702 may contain a name associated with an account. Field 704 may contain a unique identifier associated with a particular auction. Fields 706 may contain information associated with the particular auction. For example, fields associated with a particular auction may be the interactive media being bid on; the particular location within the interactive media being bid on; the time and dates being bid on; the platforms being bid on; the current bid; when the auction closes; and/or any other relevant fields. A button 708 may allow a user to set up automatic bids, as described below. A button 710 may allow a user to place a bid.

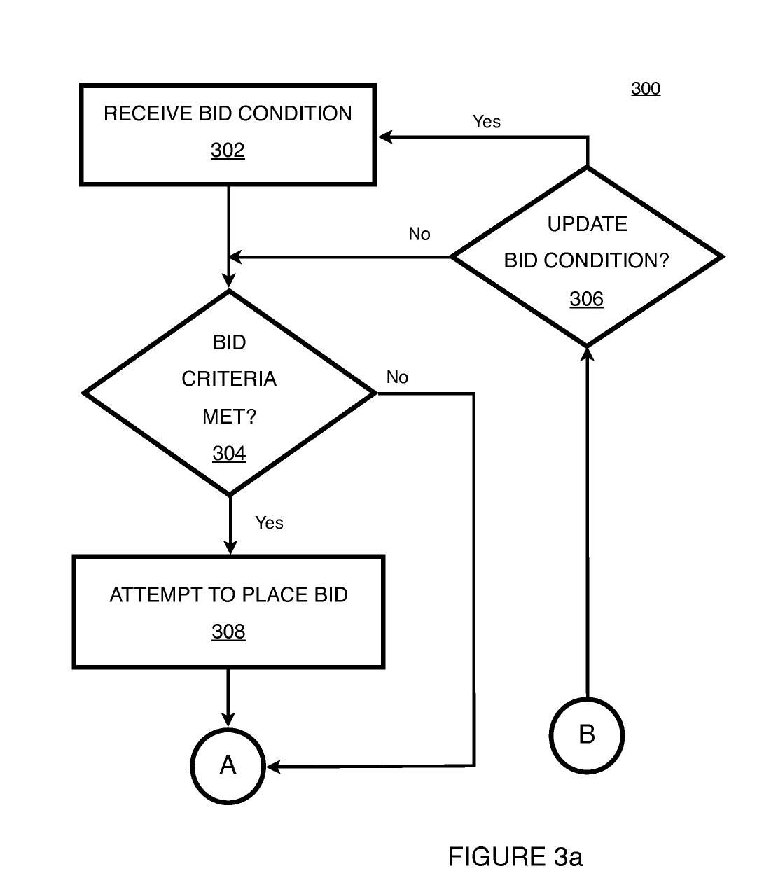

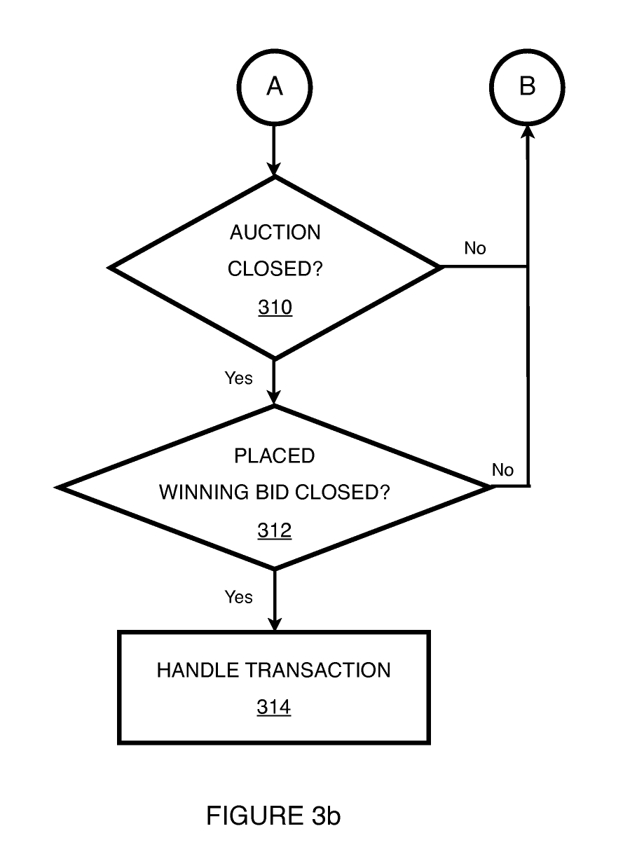

Referring now to FIG. 3, an exemplary embodiment of a flow diagram for a method 300 for automating bids in an auction or multiple auctions is illustrated. In step 302, the method 300 may receive a bid condition. The bid condition may be simple, such as “when the auction opens, place a $4.00 bid.” The bid condition may be more complicated, such as “place a bid $0.50 higher than the most current bid unless or until the current bid exceeds $4.00.” The user may also specify that the bid is rounded up to certain intervals. Additionally, the user may specify that she wants to apply this bid condition to all similar auctions held on the same day of the week. Additionally, the user may specify that the criteria should be applied to all media bid on at that time in similar geographic locations and platforms. Any other variety and combination of bid conditions may be specified. It should be understood that, even though these bid conditions have been presented in a way that is easily understood by a reader, the bid conditions may actually be in a format that is recognizable to a computer, such as machine code.

In step 304, the method 300 may determine if the auction has reached any criteria specified in the bid condition. If the auction has not reached any criteria specified in the bid condition, then the method 300 may determine if the auction is closed 310. If the bidding is not closed, then the method 300 may determine if the user wants to update the bid condition 306. If the method 300 determines that the user does not want to update the bid condition, then the method 300 may determine if the bid criteria is met 304. If the user wants to update the bid condition, then the method 300 may receive a bid condition 302. The method 300 may continue to wait for either the auction to reach any criteria specified in the bid condition or the auction to close, and may update the bid condition when appropriate.

If the auction does reach a criteria specified by a bid condition, then the method 300 may attempt to place a bid 308. As explained earlier, a bid may be rejected for any number of reasons. Afterwards, the method 300 may determine if the auction is closed 310. If the bidding is not closed, then the method 300 may continue to wait for either the auction to reach another criteria specified in the bid condition or the auction to close, and may update the bid condition when appropriate.

If the auction closes, the method 300 may determine if the user placed the winning bid 312. If the user did not place the winning bid, and the type of bid condition that surveys multiple auctions, then the method 300 may wait for an updated bid condition, and once the next relevant auction opens, the method 300 may also wait for the auction to close, as described above. If the bidding closes and the auction was the only auction for which this automated bid was relevant, then the method 300 may end (not shown).

If the user did place the winning bid, then the method 300 may handle the transaction 314. The transaction can include any known method of handling a transaction, such as, for example, debiting a credit card or debiting any other type of account. After handling the transaction, the method 300 may end if this bid condition was specific to only this auction (not shown). If the bid condition is relevant for other auctions, then the method 300 may wait for an updated condition, and once the next relevant auction open, the method 300 may also wait for the auction to close, as described above (not shown).

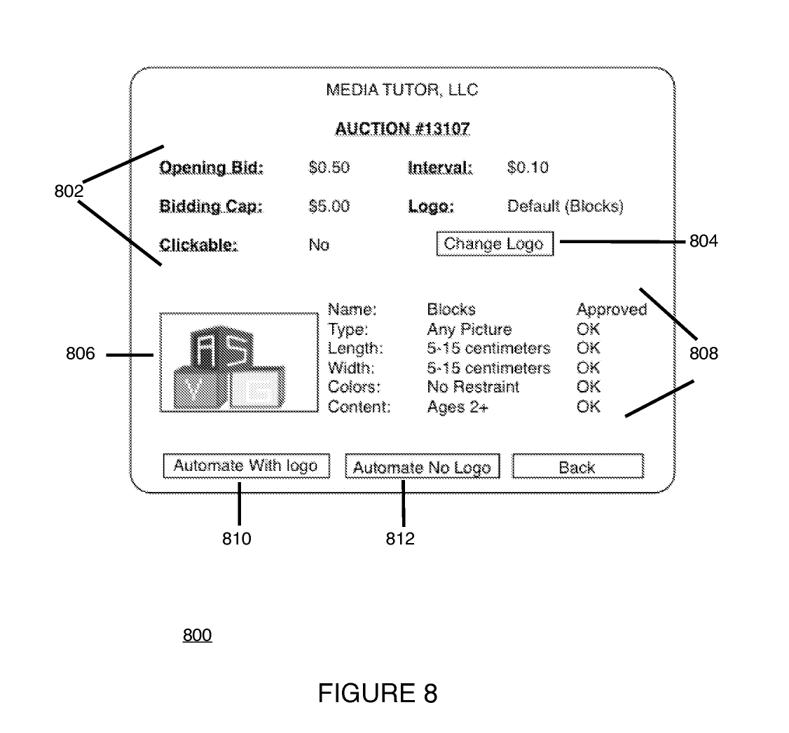

Referring now to FIG. 8, an exemplary embodiment of a user interface 800 allowing a user to set up automatic bids is illustrated. Fields 802 may be attributes of the automatic bids. For example, a field may contain an opening bid a user wants for a particular auction; a highest bid the user is willing to place for the particular auction; intervals that the user is willing to increase a bid in the event that the user's most recent bid is exceeded by another user; a currently selected file; whether users of the interactive media will be able to click on the file when the file is embedded in the interactive media; and/or any other relevant fields. Some fields may or may not be editable. For example, if the interactive media is a video game, and a player of the video game has to click on the screen as part of the game, making the file clickable may not be desirable as clickable files may interrupt game play. In such an instance, a field may just indicate an attribute's status. A button 804 may allow a user to change a current file. A field 806 may preview a currently selected file. If the file is an image, then the field 806 may show the image, a thumbnail of the image, or any other suitable known method of previewing an image. If the file is a video, then the field 806 may show a single image from the video, cycle through some images of the video, allow a user to play the video, automatically show the video once, automatically repeatedly play the video, or any other suitable known method of previewing a video. If the file is an audio file, then the field 806 may show an audio player that allows a user may play the file, the file may play once automatically, the file may repeatedly play automatically, or any other suitable known method of previewing an audio file. Fields 808 may display the interactive media's requirements as compared against the file's attributes. For example, the interactive media may expect: a certain type of file; a file with a certain height, or a height within a certain range; a file with a certain width, or a width within a certain range; a file with a certain duration, or a duration with a certain range; colors that match, or at least do not clash with, the colors in the interactive media; subject matter, such as a character, that matches with the interactive media; content appropriateness; and/or any other requirements an interactive media may have. If the attributes of the file match the requirements of the interactive media, then the file may be accepted. A button 810 may be used to automate bids with the currently selected file. A button 812 may be used to automate bids without tying the automated bids to any particular file; with such an option, a user may set automated bids at one time and, if the user wins the auction, select a file to associate with the winning auction later.

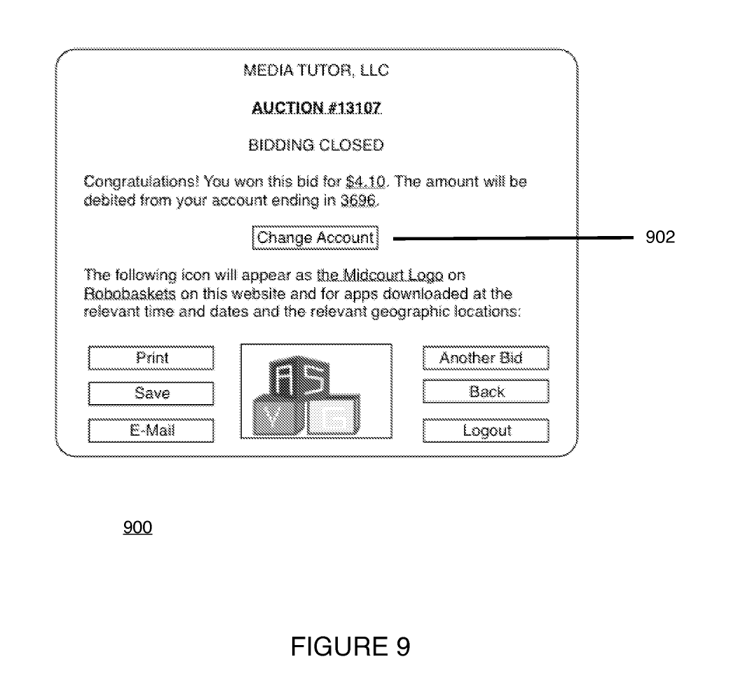

Referring now to FIG. 9, an exemplary embodiment of a screenshot 900 of a winning bid once an auction closes. A user account may have one or more payment accounts associated with it. A payment account may be, for example, a bank account, a credit card number, a PayPal account, and/or any other known payment account. A button 902 may allow a user to select a payment account from which the winning bid amount may be debited.

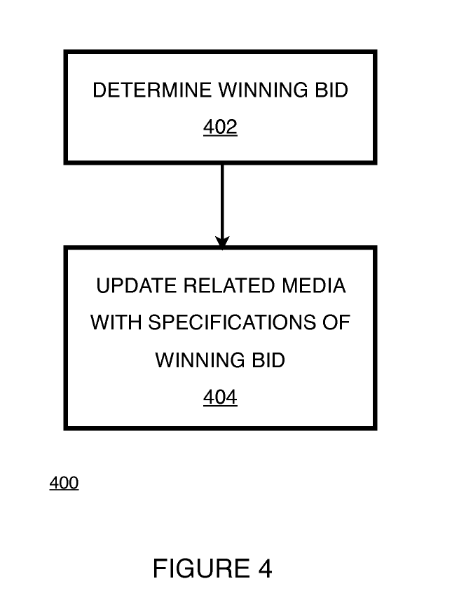

Referring now to FIG. 4, an exemplary embodiment of a flow diagram for a method 400 handling a winning bid is illustrated. In step 402, the method 400 may determine the winning bid, as described earlier.

In step 404, the method 400 may update the relevant media with the appropriate files from the winning bid. For example, the relevant media may be a particular video game or video, and the relevant media may be updated by embedding an image or video file of the winning bid into the relevant media for a particular time, geographic region, and/or platform.

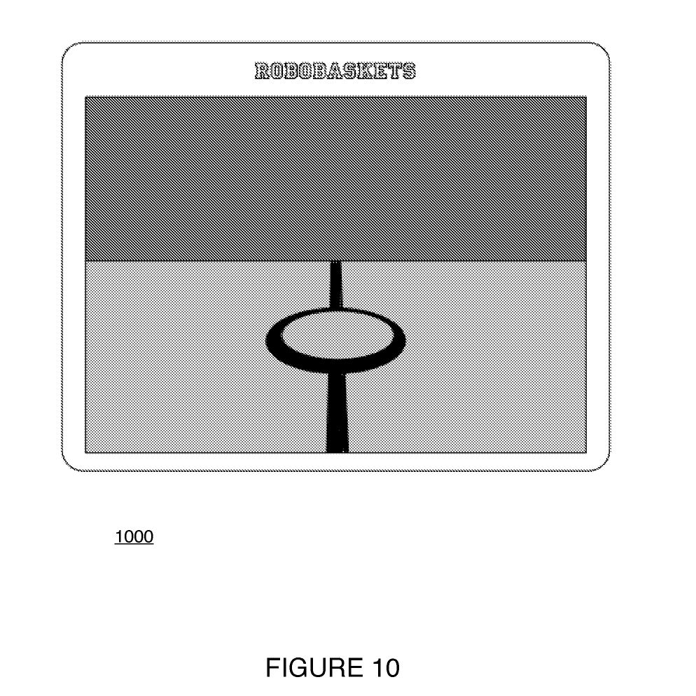

Referring now to FIG. 10, an exemplary embodiment of a screenshot of an interactive media is illustrated.

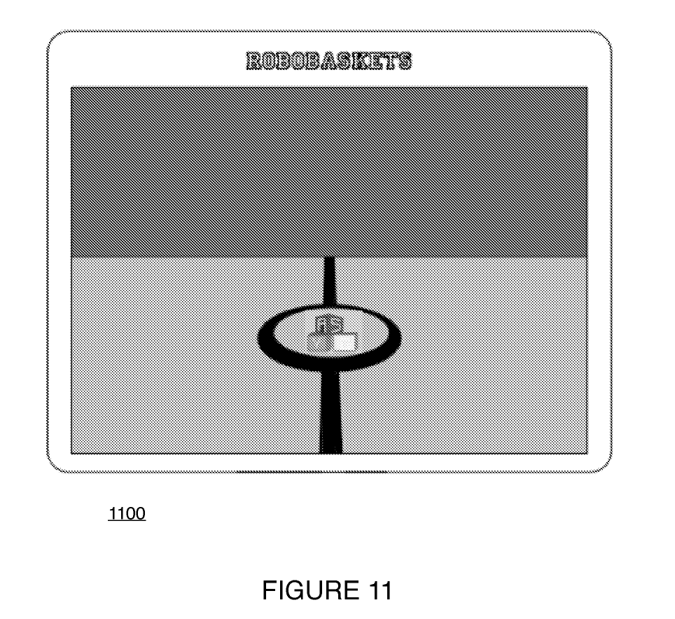

Referring now to FIG. 11, an exemplary embodiment of a screenshot of an interactive media with an advertisement embedded is illustrated.

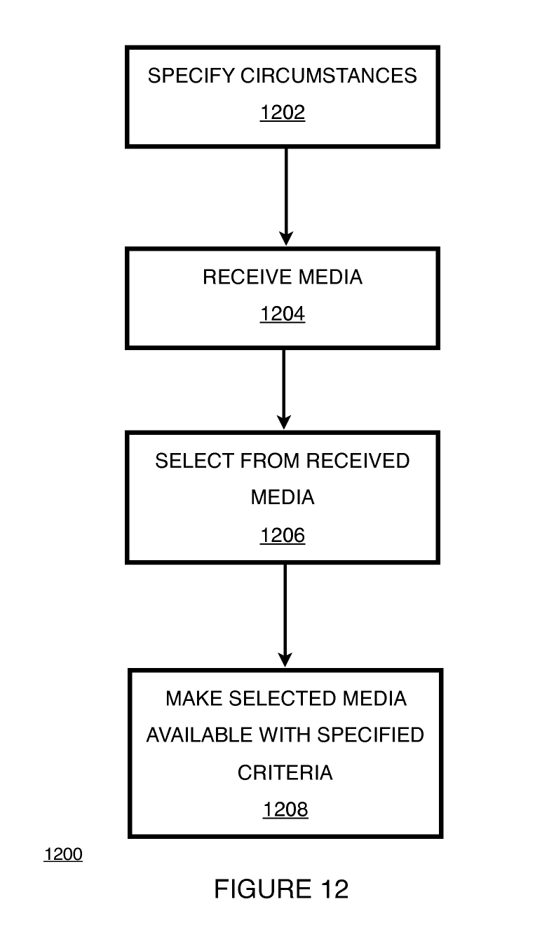

Referring now to FIG. 12, an exemplary embodiment of a flow diagram for a method 1200 of selecting a subset of media from a set of received media. In step 1202, circumstances may be specified. For example, the specified circumstances may be that a website posts a request for users to submit interactive media and will split revenue generated from selected interactive with the user that submitted the interactive media. In an exemplary embodiment, for example, the specified circumstances may be that the interactive media may receive credits and allow players of the game to advance, benefit, or “cheat” with the credits.

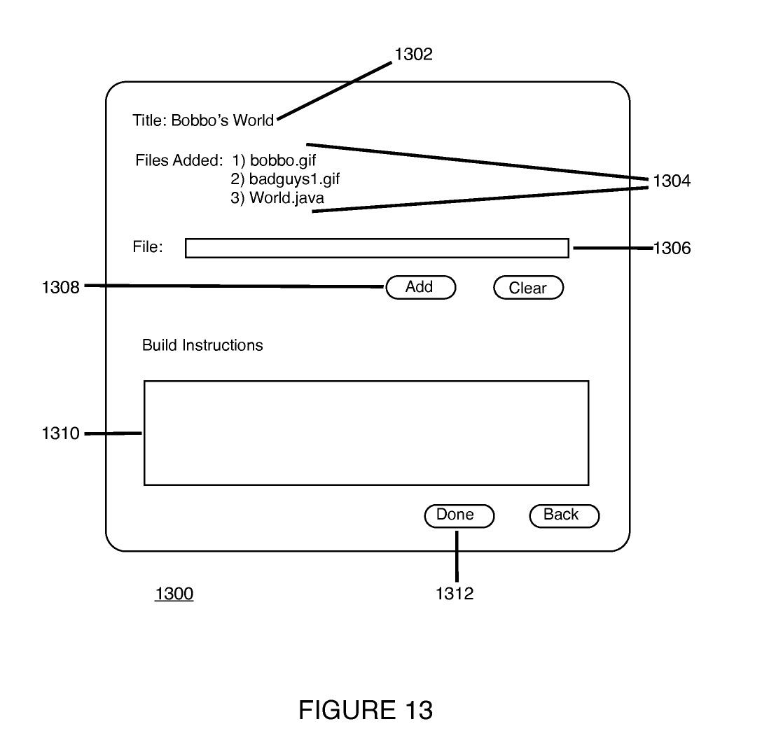

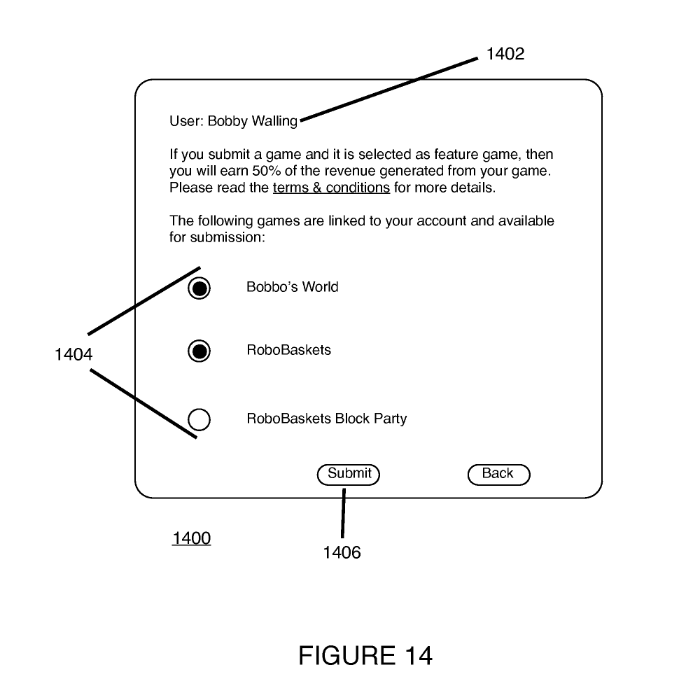

In step 1204, interactive media is received. For example, users may submit video games in response to the request for video games posted on a website. The website may receive the video game submissions from the various users. In FIG. 13, an exemplary embodiment of a user interface 1300 allowing a user to submit an interactive media is illustrated. A field 1302 may display a title of the interactive media currently being submitted. Fields 1304 may display the names of files already added that are associated with the interactive media currently being submitted. Field 1306 may accept a path or file name representing a file associated with interactive media. Button 1308 may be pressed when a file is in field 1306 and the file in field 1306 may be added to the added fields 1304. Field 1310 may allow a user to give instructions associated with the interactive media. For example, a user may give instructions on how to make the interactive media; in the case of a video game with multiple file, such instructions may be, for example, which file to run to start the video game. A button 1312 may be pressed when the appropriate files are added and instructions are given and the interactive media is ready to be submitted. In FIG. 14, an exemplary embodiment of a user interface 1400 allowing a user to submit one or more interactive media associated with an account is illustrated. A field 1402 may display a name associated with an account. The user interface 1400 may contain one or more radio buttons 1404 representing one or more submitted interactive media associated with the current account. When there is a particular offer that the user wants one or more of the user's interactive media to be considered for, the user may select one or more of the radio buttons for the respective interactive media and may select a 1406 button to submit the selected interactive media for the offer.

In step 1206, a subset of the submitted media may be selected. For example, one or more of the received video games submitted in response to the criteria specified on the website may be selected. Selection may be made in a number of ways. For example, if a company owns the website, then an employee of the website may make the selection. In another exemplary embodiment, the received videos games may be put on the website, on a certain section of the website, on another affiliated website, etc., and selections may be made based on user usage, voting, approval, etc.

In step 1208, the selected media may be made available in accordance with the specified criteria. For example, the one or more selected video games may be posted on the website and revenue generated from the one or more video games may be split with the respective users that submitted the one or more video games. Revenue may be generated, for example, through advertisements, subscriptions, fees, or any other known method. Each user may be compensated based on the interactive media that she submitted. In addition, a pool may be created and users in the pool may be compensated based on the interactive media that the users in the pool submitted. Money in the pool may be divided evenly between the users, divided among the user according to an agreed upon arrangement, and/or any other method of dividing the pool amongst the users that submitted interactive media in the pool.

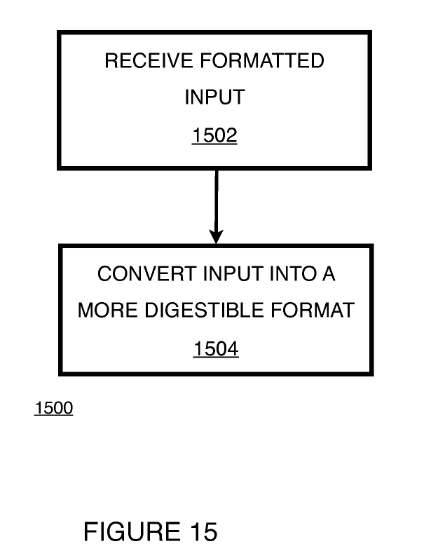

Referring now to FIG. 15, an exemplary embodiment of a flow diagram for a method 1500 for converting input into a more digestible format is illustrated. In step 1502, input in an expect format may be received. For example, in an exemplary embodiment, the method 1500 may expect to receive an outline. As one of skill in the art would know, the received input may be, for example, an XML document or any known document object model. Indentations, punctuations, keywords, tags, metadata, or any other delimiter, may be used to inform what the information in the input represents.

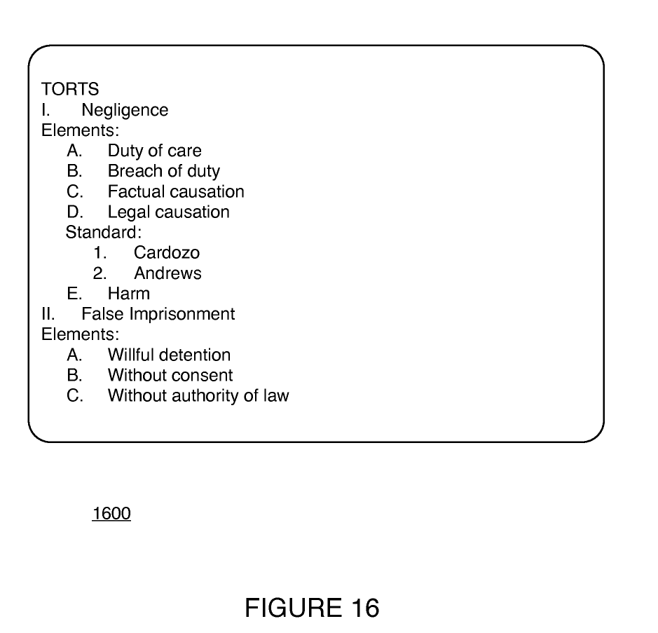

In step 1504, the input may be converted into a more digestible format. For example, the input may be converted into a quiz, notecard, or any other format that may help a user more easily study the materials. In an exemplary embodiment, the user may define how the input is parsed. For example, the user may indicate that questions may be formed by taking a topic in an outline line, the attribute of the question on the line directly below the topic, and answers to the question will be on indented lines directly below the corresponding question attribute. FIGS. 16-19 illustrate such an embodiment.

FIG. 16 illustrates an exemplary embodiment of a screen shot of an uploaded outline for Torts. The outline has three topics with attributes: 1) Negligence (with an “elements” attribute); 2) Legal causation, an element of negligence (with a “standard” attribute); and 3) False Imprisonment (with an “elements” attribute).

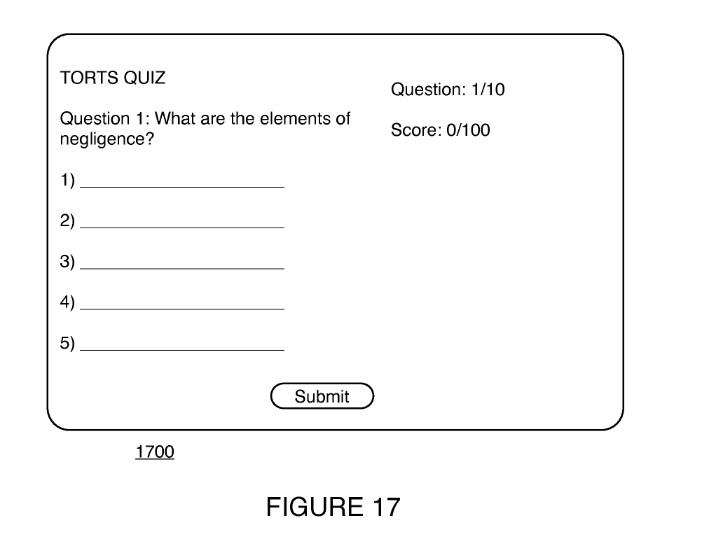

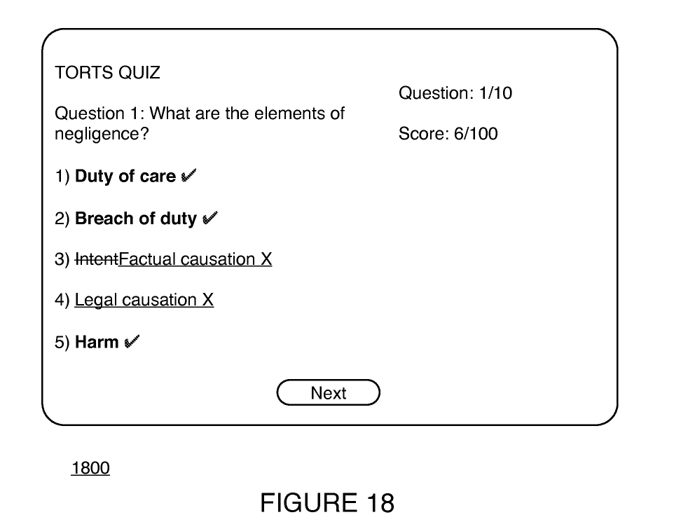

FIG. 17 illustrates an exemplary embodiment of a screen shot of a question in a converted quiz for the uploaded outline for Torts. The question asks for the elements of negligence. FIG. 18 illustrates an exemplary embodiment of a screenshot 1800 of an answer screen after a user answers three of five questions correctly.

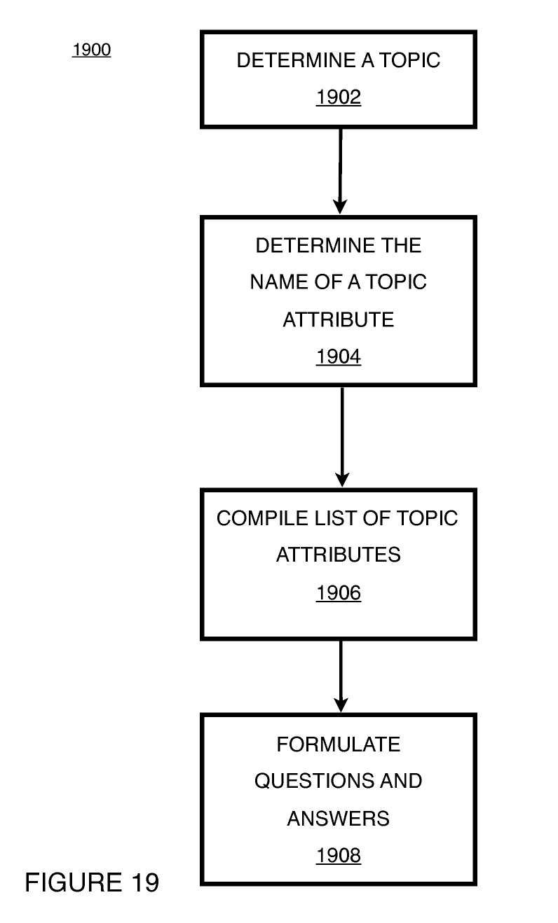

FIG. 19 illustrates an exemplary embodiment of a flow diagram for a method 1900 for converting an outline into a quiz, as shown in FIGS. 16-18. In step 1902, a topic may be determined. For example, each entry after an outline character may be a topic. For example, referring back to the outline on FIG. 16, “Negligence” after “I” may be a topic, “Duty of care” after “A” may be a topic, etc. In step 1904, a name of a topic attribute may be determined. For example, a name of a topic attribute may be each entry that does not have an outline character before such entry. The attribute may be an attribute of the topic immediate above the attribute name. For example, referring back to the outline on FIG. 16, “Elements” may be the name of a topic attribute of the “Negligence” topic; “Standard” may be the name of a topic attribute of the “Legal causation” topic; etc. In step 1906, a list of topic attributes may be compiled. For example, a topic attribute may be an entry after an indented outline character, relating to the topic in the level immediately above the entry's level. For example, referring back to FIG. 16, “Duty of care,” “Breach of duty,” “Factual causation,” “Legal causation,” and “Harm” may be the topic attributes of “Negligence—elements”; “Cardozo” and “Andrews” may be the topic attributes of “Legal causation—standards”; etc. In step 1908, a question may be formulated. For example, a check may be done to see if a list of topic attributes has one or more than one topic attributes in it. If there is only one topic attribute in the list, then the singular form may be used in formulating a question. If there are more than one topic attributes in the list, then the plural may be used. The question may be in the form of “What [is/are] the <name of topic attribute>[s] of <topic>?”. If the plural is used, there may be a check to see is the attribute name is in the plural form, and if not, the plural may be used. For example, referring now to FIG. 17, Question 1 from the outline on FIG. 16 may be “What are the elements of negligence?”. There may be five answer spaces, corresponding to the five elements of negligence listed in the outline.

In an exemplary embodiment, the input may be parsed according to a predetermined algorithm without an indication from the user as to how the information should be parsed. In an exemplary embodiment, the input may be parsed based on how the format that the input is presented; for example, input in an outline format may be parsed differently than input in sentence format. In an exemplary embodiment, a user may be able to specify how the input may be parsed. In an exemplary embodiment, the user may be shown the converted digestible format and may be given the chance to edit the resulting more digestible output.

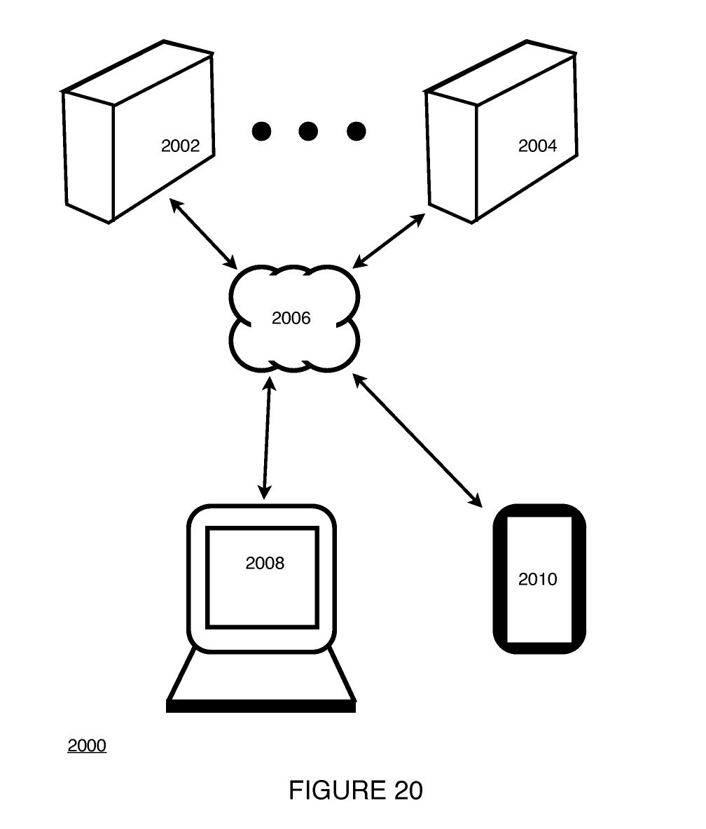

Referring now to FIG. 20, an exemplary embodiment of a system 2000 capable of implementing the present invention is illustrated. A user may access portions of the present invention through, for example, a mobile communication device 2010, such as a smart phone, or a computing device 2008, such as a laptop. The present invention may be implemented on software stored on a server 2002, stored across multiple servers 2002 and 2004, stored in the cloud 2006 (for example, on a cloud server), stored on a local device, such as a computing device 2008 or a mobile communication device 2010, or any combination of the preceding.

In an exemplary embodiment, one website may combine the various aspects of this application with the various aspects of Provisional Application No. 61/531,045 filed Sep. 5, 2011, titled “System, Method, and Computer-Readable Medium for Tutoring with Video Games and Interactive Video.” In such an embodiment, there may be several types of users: interactive media creators, students, teachers, advertisers, etc. An interactive media creator may submit interactive media to the website. The submitted interactive media may be selected and provided on the website. A teacher may submit quizzes to the website. A student may also upload notes to the website, and the website may present the notes in a quiz format. Students may then take the quizzes to receive credits and use the credits in the interactive media. Advertisers may bid on advertising space within the interactive media on which to place the logos at various times. The advertisers may bid on displaying their logos only to users that play the interactive media in specific geographic locations. For example, a local company may only be interested in displaying its logo to users that are within a few miles of its location. Other specifications, as described above, may be specified as well.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus, including smart phones and other mobile devices, adapted for carrying out the methods described herein is suited. A typical combination of hardware and software with a computer system with a computer program that, when being loaded and executed, controls the computer system such that it carries out the methods described herein. Another typical combination may be a general-purpose computer system with a computer program that, when being loaded and executed, controls the computer system such that it carries out the methods described herein. Another typical combination may be both a mobile communication device with a computer system with a computer program that, when being loaded and executed, controls the computer system such that it carriers out the methods described herein and a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method, comprising the steps of:
relating interactive media, auctions, and user accounts, the user accounts comprising login information, advertising file information, and bidding information; and
communicating with one or more user devices,
wherein the one or more user devices may be used to place a bid in one of the auctions by one of the user accounts for one of the interactive media, and
wherein an auction ends and a winning bid is determined, and the advertising file information associated with the winning bid is dynamically incorporated into the interactive media.

2. The method of claim 1, wherein the interactive media is a video game.

3. The method of claim 1, wherein the interactive media comprises audio and visual components.

4. The method of claim 1, wherein the advertising file information associated with the winning bid is within a set of predetermined ranges, the set of predetermined ranges comprising a dimension range.

5. An apparatus, comprising:
one or more databases relating interactive media, auctions, and user accounts, the user accounts comprising login information, advertising file information, and bidding information; and
communication with one or more user devices,
wherein the one or more user devices may be used to place a bid in one of the auctions by one of the user accounts for one of the interactive media, and
wherein an auction ends and a winning bid is determined, and the advertising file information associated with the winning bid is dynamically incorporated into the interactive media.

6. The apparatus of claim 5, wherein the interactive media is a video game.

7. The apparatus of claim 5, wherein the interactive media comprises audio and visual components.

8. The apparatus of claim 5, wherein the advertising file information associated with the winning bid is within a set of predetermined ranges, the set of predetermined ranges comprising a dimension range.

9. A computer-readable medium, comprising:
one or more computers operable to:
relate interactive media, auctions, and user accounts, the user accounts comprising login information, advertising file information, and bidding information; and
communicate with one or more user devices,
wherein the one or more user devices may be used to place a bid in one of the auctions by one of the user accounts for one of the interactive media, and
wherein an auction ends and a winning bid is determined, and the advertising file information associated with the winning bid is dynamically incorporated into the interactive media.

10. The computer-readable medium of claim 9, wherein the interactive media is a video game.

11. The computer-readable medium of claim 9, wherein the interactive media comprises audio and visual components.

12. The computer-readable medium of claim 9, wherein the advertising file information associated with the winning bid is within a set of predetermined ranges, the set of predetermined ranges comprising a dimension range.

13. A method, comprising the steps of:
specifying conditions for interactive media,
receiving interactive media from user devices,
selecting one or more interactive media from the received interactive media, and
making the selected interactive media available in accordance with the specified conditions.

14. The method of claim 13, wherein the interactive media is a video game.

15. The method of claim 13, wherein the interactive media comprises audio and visual components.

16. The method of claim 13, wherein the specified conditions comprise file type and dimensions.

17. A method, comprising the steps of:
receiving formatted input,
wherein the received formatted input is formatted in one of one or more expected formats,
converting the received formatted input into an output that is more digestible, and
making the more digestible output available.

18. The method of claim 17, wherein the received formatted input resembles flash cards.

19. The method of claim 17, wherein the more digestible output is in a format of questions and answers.

20. The method of claim 19, wherein the formatted questions and answers are assembled into a quiz.
